(19) United States
(12) Patent Application Publication
(10) Pub. No.: US 2026/0361432 A1
(43) Pub. Date: Nov. 12, 2026

(54) BASE STATION CONTROL APPARATUS AND INTERFERENCE CANCELLATION METHOD

(71) Applicant: SK TELECOM CO., LTD., Seoul (KR)

(72) Inventors: Sang Hoon CHO, Seoul (KR); Chi Young CHOI, Seoul (KR)

(21) Appl. No.: 19/134,957

(22) PCT Filed: Sep. 21, 2023
(86) PCT No.: PCT/KR2023/014357

§ 371 Date: Jun. 2, 2025

(30) Foreign Application Priority Data
Dec. 7, 2022 (KR) 10-2022-0169780

(51) Int. Cl. H04B 17/345; H04B 17/318

(52) U.S. Cl. CPC H04B 17/345; H04B 17/328

(57) ABSTRACT

The present disclosure relates to a method for canceling cross-link interference (CLI) that occurs between base stations when a subband non-overlapping full duplex (SBFD) technology is applied.

### BACKGROUND OF THE INVENTION

### 1. Field of the Invention

The present disclosure relates to a method for canceling cross-link interference (CLI) between base stations when a subband non-overlapping full duplex (SBFD) technology is applied.

This application claims the priority of Korean Patent Application No. 10-2022-0169780, filed on Dec. 7, 2022, in the Korean Intellectual Property Office, the present disclosure of which is incorporated herein by reference in its entirety.

### 2. Description of the Prior Art

A subband non-overlapping full duplex (SBFD) technology for simultaneous use of Tx and Rx using full duplex communication in an existing TDD duplex scheme is discussed in 5G systems using a higher frequency band and a wider bandwidth than the existing LTE system.

This technology addresses the problem of the difficulty in canceling interference when the same frequency is used simultaneously for Tx and Rx operations, and refers to a technology in which a downlink (DL) and an uplink (UL) are transmitted separately for each frequency subband obtained by dividing the frequency.

In this SBFD technology, it is possible to allocate uplink resources to consecutive slot intervals.

Accordingly, it is possible to improve problems such as lack of uplink resources, latency, coverage, and uplink speed degradation that are inherent in the existing TDD system.

However, in spite of these advantages, the SBFD technology supports the simultaneous transmission of a downlink (DL) and an uplink (UL) between frequency subbands, resulting in a persistent limitation of cross-link interference (CLI) between base stations, where the DL and the UL affect each other.

### SUMMARY OF THE INVENTION

The technical problem of the present disclosure is to cancel cross-link interference (CLI) that occurs between base stations due to simultaneous transmission of a downlink (DL) and an uplink (UL) when a subband non-overlapping full duplex (SBFD) technology is applied.

A base station control apparatus according to an embodiment for achieving an aspect of the present disclosure includes a memory including instructions, and a processor configured to execute the instructions to collect signal measurement information regarding reception of a synchronization signal block (SSB) from a receiving base station that receives the SSB by using a resource allocated to an uplink in a slot in which simultaneous transmission in a downlink and an uplink between frequency subbands is supported, and based on the signal measurement information, in case that cross-link interference (CLI) between base stations is identified, control a downlink of a transmitting base station that transmits the SSB or an uplink of the receiving base station.

Specifically, the signal measurement information includes SSB reception quality measured based on synchronization signal-reference signal received power (SS-RSRP), and the processor may be configured to, in case that the SSB reception quality exceeds a predefined threshold value of a reception quality, identify that there is cross-link interference between the transmitting base station and the receiving base station.

Specifically, the signal measurement information includes a physical cell ID (PCI) of the transmitting base station, and the processor may be configured to control the downlink of the transmitting base station or the uplink of the receiving base station, based on the number of PCIs.

Specifically, the processor may be configured to, in case that the number of the PCIs is equal to or less than a predefined threshold value of the number of transmitting base stations, down-adjust a downlink output value for each transmitting base station that matches each PCI.

Specifically, the processor may be configured to, in case that the cross-link interference between base stations persists even after the downlink output value for each transmitting base station is down-adjusted, prevent an uplink from being allocated to a slot resource in which the SSB is received by the receiving base station.

Specifically, the processor may be configured to, in case that the number of PCIs exceeds a predefined threshold value of the number of transmitting base stations, prevent an uplink from being allocated to a slot resource in which the SSB is received by the receiving base station.

An interference cancellation method, which is performed by a base station control apparatus, according to an embodiment for achieving an aspect of the present disclosure includes collecting signal measurement information regarding reception of a synchronization signal block (SSB) from a receiving base station that receives the SSB by using a resource allocated to an uplink in a slot in which simultaneous transmission in a downlink and an uplink between frequency subbands is supported, and based on the signal measurement information, in case that cross-link interference (CLI) between base stations is identified, controlling a downlink of a transmitting base station that transmits the SSB or an uplink of the receiving base station.

Specifically, the signal measurement information includes SSB reception quality measured based on synchronization signal-reference signal received power (SS-RSRP), and the method may further include, in case that the SSB reception quality exceeds a predefined threshold value of the reception quality, identifying that there is cross-link interference between the transmitting base station and the receiving base station.

Specifically, the signal measurement information includes a physical cell ID (PCI) of the transmitting base station, and the controlling may include controlling the downlink of the transmitting base station or the uplink of the receiving base station, based on the number of PCIs.

Specifically, the controlling may include, in case that the number of the PCIs is equal to or less than a predefined threshold value of the number of transmitting base stations, down-adjusting a downlink output value for each transmitting base station that matches each PCI.

Specifically, the controlling may include, in case that the cross-link interference between base stations persists even after the downlink output value for each transmitting base station is down-adjusted, preventing an uplink from being allocated to a slot resource in which the SSB is received by the receiving base station.

Specifically, the controlling may include, in case that the number of PCIs exceeds a predefined threshold value of the number of transmitting base stations, preventing an uplink from being allocated to a slot resource in which the SSB is received by the receiving base station.

According to the base station control apparatus and interference cancellation method of the present disclosure, when applying subband non-overlapping full duplex (SBFD) technology, by controlling a downlink of a transmitting base station that transmits a synchronization signal block (SSB) or an uplink of a receiving base station that receives the SSB in a slot in which simultaneous transmission in a downlink and an uplink between frequency subbands is supported, based on the reception quality of the SSB received through an uplink resource, cross-link interference (CLI) occurring between the transmitting base station and the receiving base station can be efficiently canceled.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is an exemplary diagram illustrating an SBFD-based full-duplex communication environment according to an embodiment of the present disclosure;

FIG. 2 is an exemplary diagram illustrating a configuration of a base station control apparatus according to an embodiment of the present disclosure;

FIG. 3 is an exemplary diagram illustrating an interworking environment between base station control apparatus according to an embodiment of the present disclosure; and

FIG. 4 is a flowchart illustrating an interference cancellation method according to an embodiment of the present disclosure.

DETAILED DESCRIPTION OF THE EXEMPLARY EMBODIMENTS Hereinafter, various embodiments of the present disclosure will be described with reference to the accompanying drawings.

The present disclosure relates to a subband non-overlapping full duplex (SBFD) technology.

As the LTE system and the 5G system use the same OFDM communication scheme, similar standards are applied thereto.

However, the LTE system may be configured mainly based on a fixed format, whereas the 5G system may be configured to have a dynamic configuration and mainly use a TDD scheme to increase a bandwidth and improve frequency efficiency compared to the LTE system in which an FDD communication scheme is mainly used.

However, in case that the TDD scheme is used, when a downlink (DL) signal is transmitted using a half-duplex communication scheme, an uplink (UL) signal is unable to be transmitted, and a resource for a DL is used more than an uplink (UL) resource to increase a speed, thereby reducing the resource allocation opportunities for the UL.

For example, in South Korea, telecommunications companies have agreed to use the same DDDSU slot format.

The reason why telecommunications companies have agreed to use the same slot format is that if a slot format is different in a TDD scheme, when one operator or base station performs DL transmission while another base station performs UL transmission, interference between them causes communication difficulties in a base station using an uplink (UL), which has relatively lower power strength than the downlink (DL), due to interference from a downlink (DL) signal.

This is because even when each communication company uses different frequencies, adjacent frequencies will inevitably be subject to interference due to strong signal transmissions, and even if there is a predetermined frequency, signals will also be generated in a region corresponding to a harmonic.

For these reasons, when using TDD in environments where adjacent frequencies or the same frequency is used, the same slot format should be employed.

However, in TDD transmission, the lack of uplink (UL) resources imposes limitations on providing services that require a large amount of uplink (UL) resources.

In addition, since an area allocated to an uplink (UL) resource is small, data retransmission may occur, or the latency of real-time data transmission may increase, resulting in degradation of data transmission quality.

Further, since uplink (UL) resource allocation does not occur continuously, coverage limitation occurs even in the same system, such as uplink (UL) retransmission.

In order to compensate for these disadvantages, research on subband non-overlapping full duplex (SBFD) is being conducted.

In the SBFD technology, it is possible to allocate uplink (UL) resources to consecutive slot intervals, thereby improving the problem of existing TDD schemes such as lack of uplink (UL) resources, latency, coverage, and uplink speed degradation.

In addition, depending on a service, a specific base station is mainly used for downlink (DL) resources, and a specific base station is mainly used for uplink resources.

However, in a full-duplex communication method that simultaneously uses DL and UL signals, the problem of cross-link interference (CLI) between DL and UL, which affect each other, remains.

This cross-link interference may largely include inter-base station interference and inter-UE interference, and especially in the case of inter-base station interference, there is no way to solve the interference.

In this regard, research on this issue is ongoing in the 3GPP standardization process. In 3GPP standardization meetings, it has been agreed to use a resource of existing channels or signals, such as a synchronization signal block (SSB), to measure inter-base station cross-link interference. Accordingly, an embodiment of the present disclosure proposes a new method capable of canceling cross-link interference that occurs between base stations due to simultaneous DL and UL transmission, based on the reception quality of an SSB when the SBFD specification is applied.

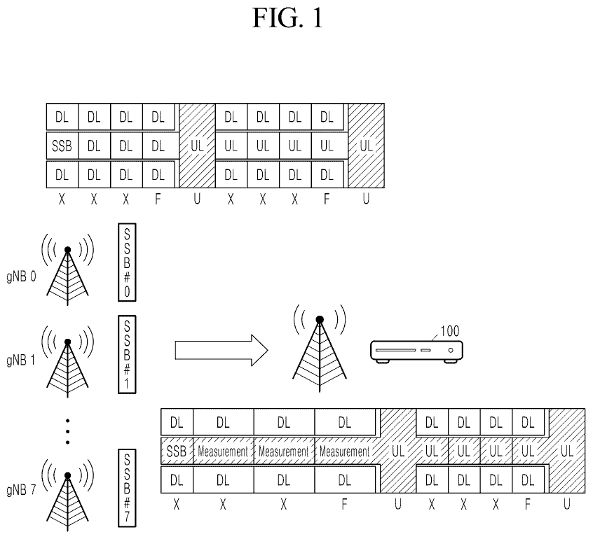

In this regard, FIG. 1 illustrates an example of an SBFD-based full-duplex communication environment according to an embodiment of the present disclosure.

As shown in FIG. 1, in the SBFD-based full-duplex communication environment according to an embodiment of the present disclosure, each of base stations (gNB 0, gNB 1, gNB 2, . . . , and gNB 7) receives SSBs transmitted by adjacent base stations using a resource allocated to an uplink (UL) in a slot that supports the simultaneous transmission of downlink (DL) and uplink (UL) between frequency subbands.

To this end, in the SBFD-based full-duplex communication environment according to an embodiment of the present disclosure, resource configuration is supported to enable each of the base stations (gNB 0, gNB 1, gNB 2, and gNB 7) to receive the SSB at the position of the uplink (UL) resource.

In this regard, for communication in the 5G system, a cell search should first be performed to identify a nearby cell and perform physical/logical synchronization between them.

### Here, the Cell Search Involves Receiving and

interpreting SSBs transmitted by each of the base stations (gNB 0, gNB 1, gNB 2, . . . , and gNB 7).

The SSB includes a primary synchronization signal (PSS), a secondary synchronization signal (SSS), and a physical broadcast channel (PBCH).

The physical synchronization refers to a process of adjusting an error between a start-point and a center-frequencyof a signal in a time and frequency domain, and this operation is performed through a process of interpreting the PSS.

The logical synchronization involves the discovery of a physical cell ID (PCI) allocated to each of the base stations (gNB 0, gNB 1, gNB 2, . . . , and gNB 7) and a master information block (MIB), which is a collection of essential information required for communication within the network.

The PCI is obtained by interpreting the PSS and SSS, and the MIB is information obtained by interpreting the PBCH. Meanwhile, in conventional technologies, downlink (DL) interference is measured by a UE, and uplink (UL) interference is measured through an SRS and the like received from the UE.

However, between base stations using a cross link, one base station may use a downlink (DL), while another base station may perform transmission such as a downlink (DL)/uplink (UL)/downlink (DL).

Therefore, in order to measure inter-base station interference, it is necessary to measure a case in which an uplink (UL) resource region is subject to interference from a downlink (DL) signal of an adjacent base station.

Accordingly, the SBFD-based full-duplex communication environment according to an embodiment of the present disclosure may include a configuration of a base station control apparatus 100 which is configured to collect signal measurement information regarding reception of an SSB from each of the base stations (gNB 0, gNB 1, gNB 2, . . . , and gNB 7) and, based on the collected information, identify and cancel cross-link interference that may occur between base stations (gNB 0, gNB 1, gNB 2, and gNB 7).

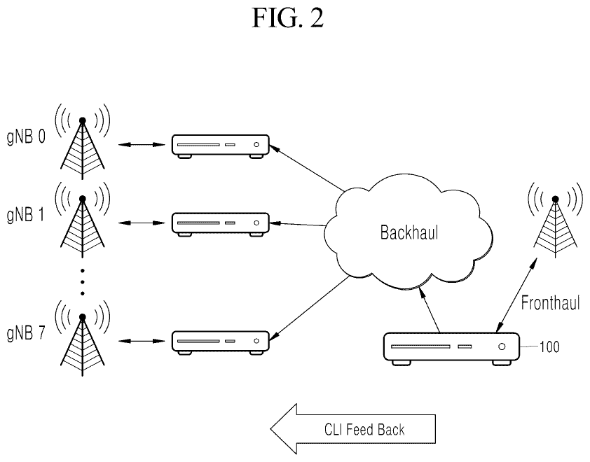

The base station control apparatus 100 refers to a device capable of performing interference control (CLI feedback) through backhaul communication with each of the base stations (gNB 0, gNB 1, gNB 2, . . . , and gNB 7) as shown in FIG. 2, for example, and may be provided in the form of a server for each of the base stations (gNB 0, gNB 1, gNB 2, . . . , and gNB 7).

The SBFD-based full-duplex communication environment according to an embodiment of the present disclosure, as described above, enables efficient cancellation of cross-link interference that occurs between base stations (gNB 0, gNB 1, gNB 2, . . . , and gNB 7) due to simultaneous transmission of the downlink (DL) and uplink (UL). The configuration of the base station control apparatus 100 to implement this cancellation is described in more detail below.

Before proceeding with the description, in each of the base stations (gNB 0, gNB 1, gNB 2, . . . , and gNB 7) in the SBFD-based full-duplex communication environment according to an embodiment of the present disclosure, not only the transmission of SSB but also the reception of SSB transmitted by adjacent base stations are performed simultaneously.

For convenience in the following description, each of the base station (gNB 0, gNB 1, gNB 2, and gNB 7) is referred to as either a transmitting base station configured to transmit SSBs, or a receiving base station configured to receive SSBs.

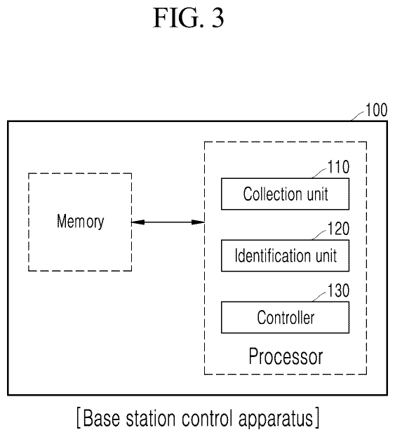

FIG. 3 schematically illustrates a configuration of the base station control apparatus 100 according to an embodiment of the present disclosure.

As shown in FIG. 3, the base station control apparatus 100 according to an embodiment of the present disclosure may include a memory including instructions and a processor configured to execute the instructions in the memory.

In particular, the processor according to an embodiment of the present disclosure may have a functional configuration including a collection unit 110, an identification unit 120, and a controller 130 depending on the implementation function corresponding to the execution of the instructions.

Finally, the base station control apparatus 100 according to an embodiment of the present disclosure can efficiently cancel cross-link interference caused by simultaneous transmission of downlink and uplink through the aforementioned functional configuration.

Below, each functional configuration of the processor to achieve this cross-link interference cancellation is explained in more detail.

The collection unit 110 is responsible for collecting signal measurement information regarding reception of an SSB.

More specifically, the collection unit 110 is configured to collect signal measurement information regarding the reception of the SSB from a receiving base station that receives the SSB using a resource allocated to an uplink (UL) in a slot that supports the simultaneous transmission of the downlink (DL) and uplink (UL) between frequency subbands.

The signal measurement information may include, for example, SSB reception quality measured based on synchronization signal-reference signal received power (SS-RSRP)

In addition, the signal measurement information may include a distance from the transmitting base station depending on the position of the uplink resource in the slot in which the SSB is received, and a physical cell ID (PCI) of the transmitting base station that transmits the SSB.

Here, the PCI may be identified by a combination of a primary synchronization signal (PSS) and a secondary synchronization signal (SSS), which are information included in the SSB, as mentioned earlier.

The identification unit 120 is responsible for identifying cross-link interference.

More specifically, the identification unit 120 is configured to identify cross-link interference between the transmitting base station that transmits the SSB and the receiving base station that receives the SSB, based on the signal measurement information collected from the receiving base station.

In this regard, the identification unit 120 may be configured to, in case that the SSB reception quality being identified based on the signal measurement information of the receiving base station exceeds a predefined threshold value of the reception quality, for example, as shown in the following mathematical expression 1, identify that there is a cross-link interference between the transmitting base station that transmits the SSB and the receiving base station that receives the SSB.

SSB reception quality>Threshold value of reception quality Mathematical Expression 1

To this end, the threshold value of reception quality according to an embodiment of the present disclosure is an attribute that coincides with the attribute of the SSB reception quality, and may be selectively configured by an operator, for example, within the range of SS-RSRP (range: 0 to 127).

Here, the SSB reception quality refers to the signal strength of the SSB signal received from a neighboring base station (gNB), and it may be understood that the higher the value, the stronger the signal strength.

The controller 130 is responsible for canceling cross-link interference.

More specifically, when it is identified that there is cross-link interference between the transmitting base station that transmits the SSB and the receiving base station that receives the SSB, the controller 130 is configured to cancel the cross-link interference by controlling the downlink (DL) of the transmitting base station or the uplink (UL) of the receiving base station.

At this time, the controller 130 may be configured to control the downlink (DL) of the transmitting base station or the uplink (UL) of the receiving base station, based on the number of transmitting base stations that have caused the cross-link interference to the receiving base station.

Here, the number of transmitting base stations that have caused the cross-link interference to the receiving base station is the same as the number of PCIs identified from the signal measurement information of the receiving base station.

In this regard, the controller 130 may, for example, be configured to down-adjust the DL output value for each transmitting base station that matches each PCI to cancel or mitigate cross-link interference in case that the number of PCIs identified from the signal measurement information of the receiving base station is equal to or less than a predefined threshold value of the number of transmitting base stations, as shown in the following mathematical expression 2.

Number of PCIs<Threshold value of the number of transmitting base stations Mathematical Expression 2

Here, when the number of PCIs identified from the signal measurement information of the receiving base stations is equal to or less than a predefined threshold value of the number of transmitting base stations, it indicates that the number of transmitting base stations subject to control is at a level where sufficient control can be achieved without excessive allocation of operating resources.

For reference, the magnitude of the DL output value for each transmitting base station subject to downward control in this manner may differ depending on the distance from the transmitting base station according to the position of the UL resource in a slot in which the SSB is received.

As a result, the influence of the interference that the DL of the resource having the adjusted output value has on the UL of the receiving base station is reduced by the adjusted output value, and accordingly, the cross-link interference identified at the receiving base station can be expected to be mitigated to some extent.

Furthermore, in case that cross-link interference persists even after the DL output value for each transmitting base station has been down-adjusted as described above, the controller 130 may be configured to perform a control such that the UL is no longer allocated to a slot resource in which the SSB is received by the receiving base station, thereby fundamentally canceling cross-link interference.

Meanwhile, in case that the number of PCIs identified from the signal measurement information of the receiving base station exceeds a predefined threshold value of the number of transmitting base stations, and thus fails to satisfy aforementioned mathematical expression 2, the controller 130 may be configured to perform a control such that the UL is no longer allocated to a slot resource in which the SSB is received by the receiving base station, thereby fundamentally canceling cross-link interference.

Here, when the number of PCIs identified from the signal measurement information of the receiving base station exceeds a predefined threshold value of the number of transmitting base stations, it indicates that the number of transmitting base stations to be controlled is increasing, requiring excessive allocation of operating resources.

Therefore, in an embodiment of the present disclosure, in order to prevent such excessive allocation of operating resources, when the number of PCIs identified from the signal measurement information of the receiving base station exceeds a predefined threshold value of the number of transmitting base stations, the UL of the receiving base station is directly controlled instead of the transmitting base station.

As described above, according to the configuration of the base station control apparatus 100 of the present disclosure, when an SBFD technology is applied, in a slot that supports the simultaneous transmission of a downlink (DL) and an uplink (UL) between frequency subbands, it is possible to efficiently cancel cross-link interference (CLI) occurring between a transmitting base station and a receiving base station by controlling the DL of the transmitting base station that transmits an SSB or the UL of the receiving base station that receives the SSB, based on the reception quality of the SSB received through an uplink (UL) resource.

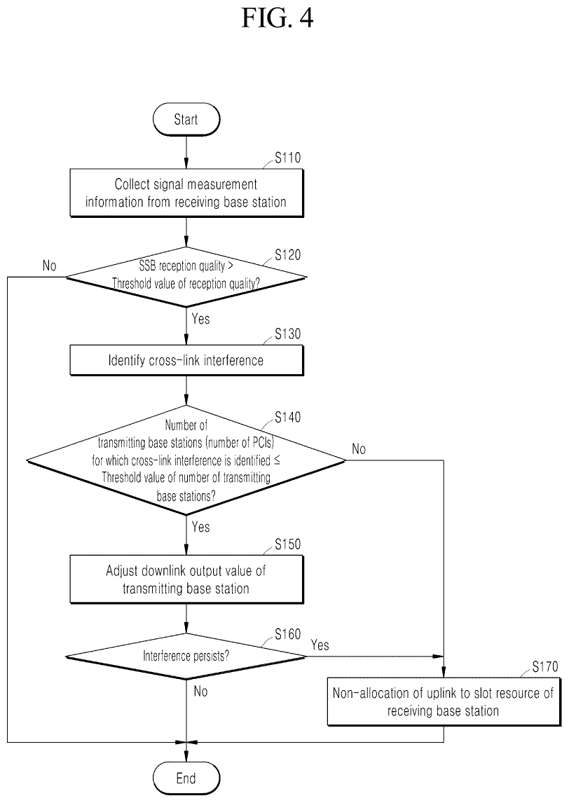

Hereinafter, an interference cancellation method according to an embodiment of the present disclosure will be described with reference to FIG. 4.

For the convenience of explanation, the base station control apparatus 100 described with reference to FIG. 3 will be referred to as an entity performing the interference cancellation method in the following description.

The base station control apparatus 100 is configured to collect signal measurement information regarding reception of an SSB from a receiving base station that receives the SSB using a resource allocated to the uplink (UL) in a slot that supports the simultaneous transmission of the downlink (DL) and uplink (UL) between frequency subbands (operation S110).

This signal measurement information may include, for example, SSB reception quality measured based on synchronization signal-reference signal received power (SS-RSRP).

In addition, the signal measurement information may include a distance from the transmitting base station based on the position of uplink (UL) resources in a slot in which the SSB is received, and a physical cell ID (PCI) of the transmitting base station that transmits the SSB.

Here, the PCI may be identified by a combination of a primary synchronization signal (PSS) and a secondary synchronization signal (SSS), which are information included in the SSB, as mentioned earlier.

Thereafter, the base station controller 100 is configured to identify cross-link interference between the transmitting base station that transmits the SSB and the receiving base station that receives the SSB, based on the signal measurement information collected from the receiving base stations (operations S120-S130).

In this regard, the base station controller 100 may be configured to, in case that the SSB reception quality being identified from the signal measurement information of the receiving base station exceeds a predefined threshold value of the reception quality, as shown in the previously mentioned mathematical expression 1, identify that there is cross-link interference between the transmitting base station that transmits the SSB and the receiving base station that receives the SSB.

To this end, the threshold value of the reception quality according to an embodiment of the present disclosure is an attribute that coincides with the attribute of the SSB reception quality, and may be selectively configured by an operator, for example, within the range of SS-RSRP (range: 0 to 127).

Here, the SSB reception quality refers to the signal strength of the SSB signal received from a neighboring base station (gNB), and it may be understood that the higher the value thereof, the stronger the signal strength.

Thereafter, when it is identified that there is cross-link interference between the transmitting base station that transmits the SSB and the receiving base station that receives the SSB, the base station control apparatus 100 is configured to cancel the cross-link interference by controlling the downlink (DL) of the transmitting base station or the uplink (UL) of the receiving base station.

At this time, the base station control apparatus 100 may be configured to control the downlink (DL) of the transmitting base station or the uplink (UL) of the receiving base station, based on the number of transmitting base stations that have caused the cross-link interference to the receiving base station.

Here, the number of transmitting base stations that have caused the cross-link interference to the receiving base station is the same as the number of PCIs identified from the signal measurement information of the receiving base station.

In this regard, the base station control apparatus 100 may be configured to, in case that the number of PCIs identified from the signal measurement information of the receiving base station is equal to or less than a predefined threshold value of the number of transmitting base stations as shown in the previously exemplified mathematical expression 2, down-adjust the DL output value for each transmitting base station that matches each PCI to cancel or mitigate cross-link interference (operations S140-S160).

Here, the number of PCIs identified from the signal measurement information of the receiving base stations being equal to or less than a predefined threshold value of the number of transmitting base stations is understood as meaning that the number of transmitting base stations subject to control is at a level where sufficient control can be achieved without excessive allocation of operating resources.

For reference, the magnitude of the DL output value for each transmitting base station subject to downward control in this manner may differ depending on the distance from the transmitting base station according to the position of the UL resource in a slot in which the SSB is received.

As a result, the influence of the interference that the DL of the resource having the adjusted output value has on the UL of the receiving base station is reduced by the adjusted output value, and accordingly, the cross-link interference identified at the receiving base station can be expected to be mitigated to some extent.

Furthermore, in case that cross-link interference persists even after the DL output value for each transmitting base station has been down-adjusted as described above, the base station control apparatus 100 is configured to perform a control such that the UL is no longer allocated to the slot resource in which the SSB is received by the receiving base station, thereby fundamentally canceling cross-link interference (operation S170).

Meanwhile, in case that in the preceding operation S140, the number of PCIs identified from the signal measurement information of the receiving base station exceeds a predefined threshold value of the number of transmitting base stations, and thus fails to satisfy aforementioned mathematical expression 2, the base station control apparatus 100 is configured to perform a control such that the UL is no longer allocated to a slot resource in which the SSB is received by the receiving base station in the same manner as in the operation S170, thereby fundamentally canceling cross-link interference.

Here, when the number of PCIs identified from the signal measurement information of the receiving base station exceeds a predefined threshold value for the number of transmitting base stations, it indicates that the number of transmitting base stations to be controlled is increasing, requiring excessive allocation of operating resources.

Therefore, in an embodiment of the present disclosure, in order to prevent such excessive allocation of operating resources, when the number of PCIs identified from the signal measurement information of the receiving base station exceeds a predefined threshold value of the number of transmitting base stations, the UL of the receiving base station is directly controlled instead of the transmitting base station.

As described above, according to the interference cancellation method according to an embodiment of the present disclosure, when an SBFD technology is applied, in a slot that supports the simultaneous transmission of a downlink (DL) and an uplink (UL) between frequency subbands, it is possible to efficiently cancel cross-link interference (CLI) occurring between a transmitting base station and a receiving base station by controlling the DL of the transmitting base station that transmits an SSB or the UL of the receiving base station that receives the SSB, based on the reception quality of the SSB received through an uplink (UL) resource.

The interference cancellation method according to an embodiment of the present disclosure may be implemented in the form O H a program instruction that can be executed by various computer means and recorded on a computer-readable medium. The computer-readable recording medium may include a program instruction, a data file, and a data structure alone or in combination thereof. The program instruction recorded on the medium may be specially designed and constructed for the present disclosure, or may be known and available to those skilled in the computer software field. Examples of the computer-readable medium include magnetic media such as a hard disk, a floppy disk and a magnetic tape, optical media such as a CD-ROM and a DVD, magneto-optical media such as a floptical disk, and hardware devices specially configured to store and execute a program instruction, such as a ROM, a RAM, and a flash memory. Examples of the program instruction include not only machine language code produced by a compiler, but a high-level language code which may be executed by a computer using an interpreter, etc. The above hardware devices may be configured to operate as one or more software modules to perform the operations of the present disclosure, and vice versa.

Although the present disclosure has been described in detail with reference to preferred embodiments, the present disclosure is not limited to the foregoing embodiments, and the technical concept of the present disclosure extends to various modifications or changes within the scope of the appended claims, which do not depart from the scope of the present disclosure as claimed therein and which are within the scope of the present disclosure as understood by those skilled in the art.

What is claimed is:

1. A base station control apparatus comprising:
a memory including instructions; and
a processor configured to execute the instructions to:
collect signal measurement information regarding reception of a synchronization signal block (SSB) from a receiving base station that receives the SSB by using a resource allocated to an uplink in a slot in which simultaneous transmission in a downlink and an uplink between frequency subbands is supported; and
based on the signal measurement information, in case that cross-link interference (CLI) between base stations is identified, control a downlink of a transmitting base station that transmits the SSB or an uplink of the receiving base station.

2. The base station control apparatus of claim 1, wherein the signal measurement information comprises SSB reception quality measured based on synchronization signal-reference signal received power (SS-RSRP), and
wherein the processor is configured to, in case that the SSB reception quality exceeds a predefined threshold value of the reception quality, identify that there is cross-link interference between the transmitting base station and the receiving base station.

3. The base station control apparatus of claim 1, wherein the signal measurement information comprises a physical cell ID (PCI) of the transmitting base station, and
wherein the processor is configured to control the downlink of the transmitting base station or the uplink of the receiving base station, based on the number of PCIs.

4. The base station control apparatus of claim 3, wherein the processor is configured to, in case that the number of the PCIs is equal to or less than a predefined threshold value of the number of transmitting base stations, down-adjust a downlink output value for each transmitting base station that matches each PCI.

5. The base station control apparatus of claim 4, wherein the processor is configured to, in case that the cross-link interference between base stations persists even after the downlink output value for each transmitting base station is down-adjusted, prevent an uplink from being allocated to a slot resource in which the SSB is received by the receiving base station.

6. The base station control apparatus of claim 3, wherein the processor is configured to, in case that the number of the PCIs exceeds a predefined threshold value of the number of transmitting base stations, prevent an uplink from being allocated to a slot resource in which the SSB is received by the receiving base station.

7. An interference cancellation method performed by a base station control apparatus, the method comprising:
collecting signal measurement information regarding reception of a synchronization signal block (SSB) from a receiving base station that receives the SSB by using a resource allocated to an uplink in a slot in which simultaneous transmission in a downlink and an uplink between frequency subbands is supported; and
based on the signal measurement information, in case that cross-link interference (CLI) between base stations is identified, controlling a downlink of a transmitting base station that transmits the SSB or an uplink of the receiving base station.

8. The interference cancellation method of claim 7, wherein the signal measurement information comprises SSB reception quality measured based on synchronization signal-reference signal received power (SS-RSRP), and
wherein the method further comprises, in case that the SSB reception quality exceeds a predefined threshold value of the reception quality, identifying that there is cross-link interference between the transmitting base station and the receiving base station.

9. The interference cancellation method of claim 7, wherein the signal measurement information comprises a physical cell ID (PCI) of the transmitting base station, and
wherein the controlling comprises controlling the downlink of the transmitting base station or the uplink of the receiving base station, based on the number of PCIs.

10. The interference cancellation method of claim 9, wherein the controlling comprises, in case that the number of the PCIs is equal to or less than a predefined threshold value of the number of transmitting base stations, down-adjusting a downlink output value for each transmitting base station that matches each PCI.

11. The interference cancellation method of claim 10, wherein the controlling comprises, in case that the cross-link interference between base stations persists even after the downlink output value for each transmitting base station is down-adjusted, preventing an uplink from being allocated to a slot resource in which the SSB is received by the receiving base station,.

12. The interference cancellation method of claim 9, wherein the controlling comprises, in case that the number of PCIs exceeds a predefined threshold value of the number of transmitting base stations, preventing an uplink from being allocated to a slot resource in which the SSB is received by the receiving base station,.

13. A computer program stored in a medium to execute the method of claim 7 in conjunction with hardware.
